(19) United States
(12) Patent Application Publication
(10) Pub. No.: US 2006/0192746 A1
(43) Pub. Date: Aug. 31, 2006

(54) Image display

(75) Inventors: Sadao Ioki, Gunma (JP); Sanji Arisawa, Niigata (JP); Seijiro Tomita, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: SOPHIA INC., ARISAWA MFG. CO., LTD., and AMITA TECHNOLOGIES, INC.

(21) Appl. No.: 10/543,560

(22) PCT Filed: Jan. 23, 2004
(86) PCT No.: PCT/JP04/00612

§ 371 Date: Jul. 26, 2005

(30) Foreign Application Priority Data
Jan. 28, 2003 (JP) 2003-19305

(51) Int. Cl. G09G 3/36

(52) U.S. Cl. 345/102

(57) ABSTRACT

The present invention provides an image display system in which an image can be seen from positions other than predetermined viewing position. The image display system includes optical means for allowing light from a backlight (810) to be transmitted to a left eye image area and a right eye image area and causing the transmitted lights from the respective image areas to enter into a left eye and a right eye of an viewer independently, and image parallax switching means for selectively displaying an image for three-dimensional display which causes parallax between both eyes of the viewer when displaying a three-dimensional image to the viewer or an image for two-dimensional display which does not cause parallax between the both eyes of the viewer when displaying a two-dimensional image to the viewer on the display area, auxiliary light sources (814) for irradiating a liquid crystal display panel (804) and causing the irradiated light to be transmitted through the left eye image area or the right eye image area and enter into the both eyes of the viewer and light source control means which turns on the backlight (810) when showing the three-dimensional image to the viewer and turns on the auxiliary light sources (814) when showing the two-dimensional image to the viewer are provided.

### TECHNICAL FIELD

The present invention relates to an image display system which can display an a three-dimensional image.

### BACKGROUND ART

Hitherto, an image display system for displaying a stereoscopic image (three-dimensional image) by displaying an right-eye image and a left-eye image having parallax using a liquid crystal display unit or the like is known (JP-A-10-63199, etc.).

[Patent Document 1] JP-A-10-63199

However, in the related art, since it is intended only to show the three-dimensional image to a viewer, the viewing angle is set to a small angle. Therefore, those who are not in the viewing angle cannot see the image, or the image appears to be extremely dark. In such an image display system, there is a problem that a wide viewing angle cannot be achieved due to the structure of an optical system thereof, when a demonstrative display for collecting people in front of the image display system is desired for people viewing from points other than a predetermined viewing zone set in front of the image display system, which may pose an impediment when appealing characteristics of the image display system.

### DISCLOSURE OF THE INVENTION

In view of the problem described above, it is an object of the present invention to provide an image display system which can view an image also from a position other than a predetermined viewing zone.

A first aspect of the invention is an image display system including a liquid crystal display panel being irradiated by a backlight and having a left eye image area and a right eye image area respectively on a display panel, optical means for allowing light from the backlight to be transmitted to the left eye image area and the right eye image area and causing the transmitted lights from the respective image areas to enter into a left eye and a right eye of an viewer independently, and image parallax switching means for selectively displaying an a three-dimensional image which causes parallax between both eyes of the viewer when showing the three-dimensional image to the viewer or a two-dimensional image which does not cause parallax between both eyes when showing the two-dimensional image to the viewer on the display area, wherein an auxiliary light source for irradiating the liquid crystal display panel and causing the irradiated light to be transmitted through the left eye image area or the right eye image area and enter into the both eyes of the viewer and light source control means which turns on the backlight when showing the three-dimensional image to the viewer, and turns on the one or a plurality of auxiliary light sources when showing the two-dimensional image to the viewer are provided.

In the first aspect of the invention, a second aspect of the invention is characterized in that when the image parallax switching means switches the image to be shown to the viewer from the three-dimensional image to the two-dimensional image, the one or a plurality of auxiliary light sources are turned on by the light source control means after switching to display from the three-dimensional image to the two-dimensional image by the image parallax switching means.

In the first and second aspects of the invention, a third aspect of the invention is characterized in that when the image parallax switching means switches the image to be shown to the viewer from the two-dimensional image to the three-dimensional image, the display is switched from the tow-dimensional image to the three-dimensional image by the image parallax switching means after turning off the one or plurality of auxiliary light sources by the light source control means.

In one of the first to third aspects of the invention, a fourth aspect of the invention is characterized in that the light source control means turns off or dims the backlight when the one or a plurality of auxiliary light sources are turned on.

In one of the first to third aspects of the invention, a fifth aspect of the invention is characterized in that the light source control means also turns on the backlight when turning on the one or a plurality of auxiliary light sources.

In one of the first to fifth aspects of the invention, a sixth aspect of the invention is characterized in that the one or a plurality of auxiliary light sources are higher in brightness than the backlight.

In one of the first to sixth aspects of the invention, a seventh aspect of the invention is characterized in that the backlight is disposed between the liquid crystal display panel and the one or a plurality of auxiliary light sources.

In one of the first to seventh aspects of the invention, an eighth aspect of the invention is characterized in that the one or a plurality of auxiliary light sources are composed of one or a plurality of surface light sources.

In one of the first to eighth aspects of the invention, a ninth aspect of the invention is characterized in that viewer detection means for detecting existence of the viewer, and the light source control means turns on the one or a plurality of auxiliary light sources when the existence of the viewer is not detected by the viewer detection means.

Therefore, according to the first aspect of the invention, the clear three-dimensional image can be provided by the backlight which irradiates a light for the left eye and a light for the right eye independently when displaying the three dimensional image, while the two-dimensional image with a wide viewing angle can be displayed by the one or a plurality of auxiliary light sources which irradiates the light transmitting through both the left eye image area and right eye image areas and reaching both eyes of the viewer when displaying the two-dimensional image, whereby an optimal image (a three-dimensional image or a two dimensional image) depending on the position of the viewer can be displayed.

According to the second aspect of the invention, since the one or a plurality of auxiliary light sources are turned on by the light source control means after switching the three-dimensional image the two-dimensional image, generation of cross-talk in the three-dimensional image is avoided by preventing the left-eye image and the right-eye image from reaching the both eyes by the one or a plurality of auxiliary light sources which widens the viewing angle, and switching from the three-dimensional image to the two-dimensional image is achieved without giving a feeling of discomfort to the viewer.

According to the third aspect of the invention, since switching to the three-dimensional image is performed after the one or a plurality of auxiliary light sources are turned off, both of the left-eye image and the right-eye image reach both eyes by illuminating the one or a plurality of auxiliary light sources. Therefore, by switching to the three-dimensional image after causing the light from the backlight to reach the both eyes of the viewer by turning off the one or a plurality of auxiliary light sources, generation of the cross-talk in the left-eye image and the right-eye image is reliably prevented, and hence switching from the image for two-dimensional display to the image for three-dimensional display can be performed smoothly without giving a sense of discomfort to the viewer.

According to the fourth aspect of the invention, since the backlight is turned off or dimmed when turning on the auxiliary light source, durability of the device can be improved by controlling heat generation of the light source and promotion of energy saving is achieved by controlling power consumption.

According to the fifth aspect of the invention, since the backlight is also turned on when turning on the auxiliary light source, the angle of visibility when displaying the image for two-dimensional display can be enlarged by increasing the light amount transmitting through the liquid crystal display panel.

According to the sixth aspect of the invention, since the auxiliary light source is higher in brightness than the backlight, the angle of visibility when displaying the image for two-dimensional display can be enlarged.

According to the seventh aspect of the invention, since the backlight is disposed between the liquid crystal display panel and the auxiliary light source, the lights for the left eye and for the right eye can be incident into the liquid crystal display panel without being intercepted by the auxiliary light source.

According to the eighth aspect of the invention, since the auxiliary light source is composed of the surface light source, the light amount can further be increased to enlarge the angle of visibility when displaying the image for two-dimensional display.

According to the ninth aspect of the invention, when the existence of the viewer is not detected by the viewer detection means, the auxiliary light source is turned on to enlarge the angle of visibility, so that the viewer can view from a range larger than that for the image for three-dimensional display.

### BRIEF DESCRIPTION OF THE DRAWINGS

FIG. 1 is an exploded perspective view showing an optical system of an image display system according to an embodiment of the present invention.

FIG. 2 is a block diagram showing a control system of the same.

FIG. 3 is a plan view of the optical system of the same.

FIG. 4 is a flowchart showing an example of light source control.

FIG. 5 is an exploded perspective view showing the optical system of the image display system according to another embodiment.

### BEST MODE FOR CARRYING OUT THE INVENTION

Referring now to the drawings, an embodiment of the present invention will be described.

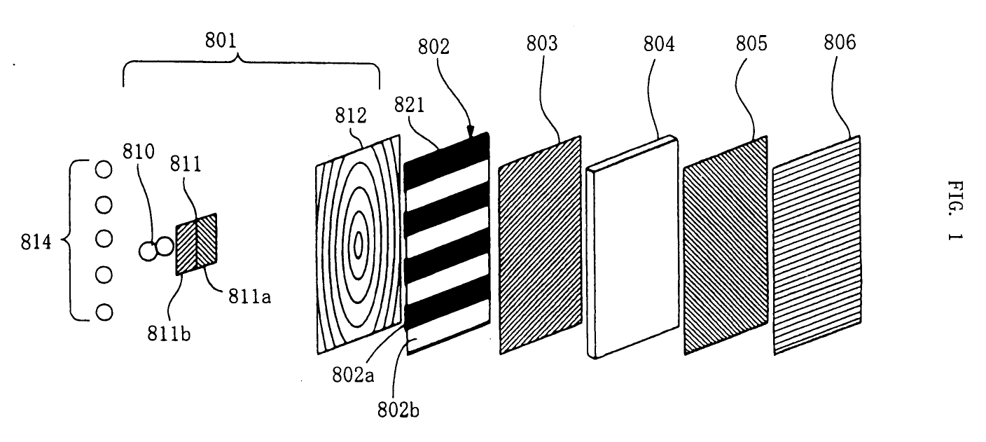

FIG. 1 is an exploded perspective view showing an optical system of an image display system according to an embodiment of the present invention.

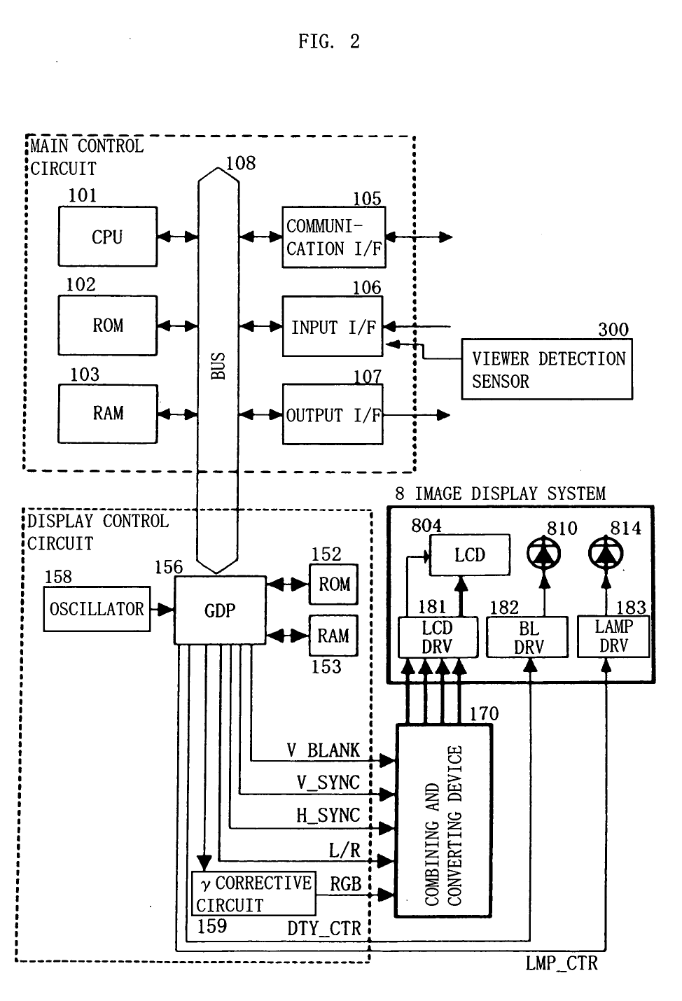

FIG. 2 is a block diagram showing a control system of the same.

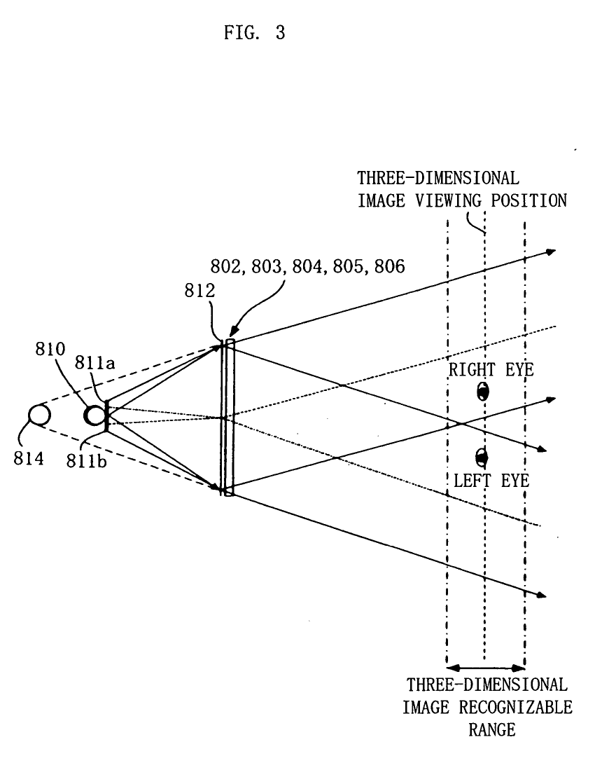

FIG. 3 is a plan view of the optical system of the same.

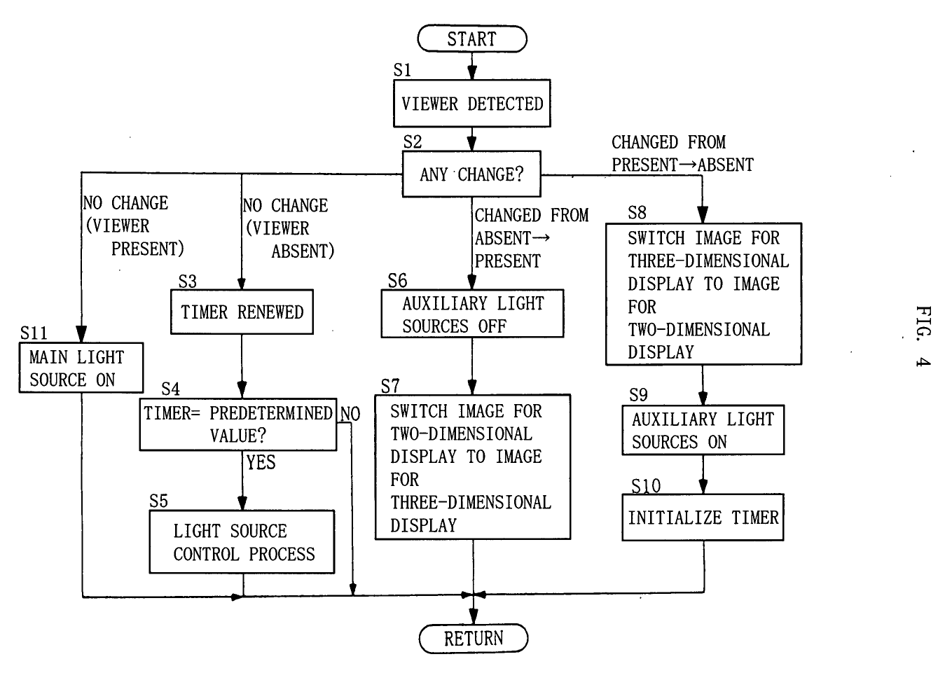

FIG. 4 is a flowchart showing an example of light source control.

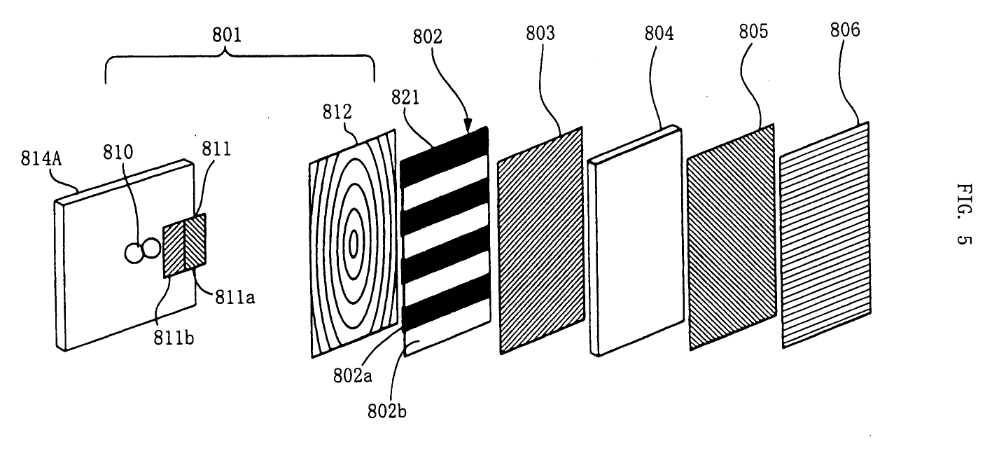

FIG. 5 is an exploded perspective view showing the optical system of the image display system according to another embodiment.

### BEST MODE FOR CARRYING OUT THE INVENTION

Referring now to the drawings, an embodiment of the present invention will be described.

FIG. 1 shows an example of an image display system 8 to which the present invention is applied, and a light source 801 (main light source) includes a light emitting device 810, a polarizing filter 811, and a Fresnel lens 812.

The light emitting device (backlight) 810 as a main light source is composed of a point light source such as white light emitting diode (LED) or linear light sources such as cold-cathode tube arranged in parallel. The polarizing filter 811 consists of a left area 811b and a right area 811a which are adapted to provide different polarizations to lights transmitting therethrough (for example, to differentiate between the polarization axes of the lights transmitting through the left area 811b and the right area 811a by 90 degrees). The Fresnel lens 812 has a lens surface having a concentric microstructures on one side.

Only the light emitted from the light emitting device 810 and having predetermined polarizations can be transmitted through the polarizing filter 811. In other words, the light emitted from the light emitting device 810 which is passed through the left area 811b of the polarizing filter 811 and the light passed through the right area 811a thereof are irradiated on the Fresnel lens 812 as lights having different polarizations. As will be described later, the light passed through the left area 811b of the polarizing filter 811 reaches the right eye of the viewer, and the light passed through the right area 811a reaches the left eye of the viewer.

It is not necessarily required to use the light emitting device and the polarizing filter, and it's only necessary that the lights of different polarizations be irradiated from different positions. For example, it may be adapted in such a manner that two light emitting devices generating lights of different polarizations are provided so that the lights of different polarization are irradiated to the Fresnel lens 812 from different positions.

The lights transmitted through the polarizing filter 811 are irradiated on the Fresnel lens 812. The Fresnel lens 812 is a convex lens, and refracts optical paths of light emitted from the light emitting device 810 in a diffusing manner into substantially parallel lights, then allows the same to pass through a micro-patterned half wave retarder 802 and then to be irradiated onto a liquid crystal display panel 804.

At this time, the light irradiated through the micro-patterned half wave retarder 802 is emitted so as not to diffuse in the vertical direction, and is irradiated on the liquid crystal display panel 804. In other words, the light transmitted through a specific area of the micro-patterned half wave retarder 802 is transmitted through specific units of display of the liquid crystal display panel 804.

Regarding the lights irradiated to the liquid crystal display panel 804, the light passing through the right area 811a of the polarizing filter 811 and the light passing through the left area 811b thereof are incident onto the Fresnel lens 812 at different angles, are refracted by the Fresnel lens 812, and are emitted from the liquid crystal display panel 804 along the left and right paths respectively.

The liquid crystal display panel 804 is provided with liquid crystal comprising liquid crystal molecules oriented and twisted at a predetermined angle (for example, 90 degrees) and disposed between two transparent plates (for example, glass plates), to form, for example, of a TFT type liquid crystal display panel. The light incident upon the liquid crystal display panel is emitted with a polarization axis rotated by 90 degrees in a state in which no voltage is applied to the liquid crystal. On the other hand, when a voltage is applied to the liquid crystal, twisting of the liquid crystal is released, and the incident light is emitted without changing the polarization.

The micro-patterned half wave retarder 802 and a polarizing plate 803 (second polarizing plate) are disposed on the side of the light source 801 of the liquid crystal display panel 804, and a polarizing plate 805 (first polarizing plate) is disposed on the viewer side.

The micro-patterned half wave retarder 802 includes regions which change the phase of light ray transmitting therethrough disposed at fine intervals repeatedly.

More specifically, a light transmitting base material is formed with regions 802a having the first polarization characteristics of a minute width, and regions 802b each having the same width as the width of the regions 802a and having the second polarization characteristics different from the first polarization characteristics, and arranged at minute intervals repeatedly.

In other words, the regions 802a which have the first polarization characteristics and change the phase of light transmitting therethrough by the ½ wave plates provided at minute intervals and the regions 802b which have the second polarization characteristics same as the polarization characteristics of the transmitting light and do not change the phase of light ray transmitting therethrough since the ½ wave plates 821 are not provided are arranged repeatedly at minute intervals.

The regions 802a are disposed so that the optical axis thereof is inclined by 45 degrees with respect to a polarization axis of the light transmitting through the right area 811a of the polarizing filter 811, thereby emitting the light transmitted through the right area 811a with its polarization axis rotated by 90 degrees.

In other words, polarization axis of the light transmitting through the right area 811a is rotated by 90 degrees to equalize to that of the light transmitting through the left area 811b. In other words, the regions 802b having the second polarization characteristics are not provided allow lights passed through the left area 811b and having the same polarization as the polarizing plate 803 to be transmitted therethrough. The regions 802a having the first polarization characteristics cause the light passed through the right area 811a and having the polarization axis orthogonal to the polarizing plate 803 to be rotated so as to equalize the polarization axis thereof to that of the polarizing plate 803 before emission.

The array of regions of each polarization characteristics of the micro-patterned half wave retarder 802 is adapted to have substantially the same pitch as the unit of display of the liquid crystal display panel 804 to differentiate polarization of the lights transmitted therethrough by each unit of display (that is, by each horizontal line of the unit of display). Therefore, the polarization characteristics of the micro-patterned half wave retarder 802 are differentiated for each of the corresponding horizontal lines (scanning line) as the unit of display of the liquid crystal display panel 804, whereby the directions of lights emitted from the adjacent horizontal lines are different.

Alternatively, the array of the regions having the polarization characteristics of the micro-patterned half wave retarder 802 may have a pitch which is integral multiple of the pitch of the unit of display of the liquid crystal display panel 804, so that the polarization characteristics are differentiated for each set of a plurality of units of display on the micro-patterned half wave retarder 802 (that is, for each set of the plurality of horizontal lines as the unit of display), thereby differentiating the polarization of the lights transmitted therethrough for each set of the plurality of units of display. In this case, the polarization characteristics of the micro-patterned half wave retarder are different for each set of the plurality of horizontal lines as the unit of display (scanning lines), and hence the directions of the emitted lights are different for each set of plurality of horizontal lines.

In this case, since it is necessary to irradiate differently polarized lights onto the adjacent units of display of the liquid crystal display panel 804 (horizontal lines) for each region having a polarization characteristics of the micro-patterned half wave retarder 802, the lights to be irradiated on the liquid crystal display panel 804 after transmitting through the micro-patterned half wave retarder 802 must be controlled to diffuse vertically.

In other words, the regions 802a of the micro-patterned half wave retarder 802 for changing the phase of the light change the light transmitting through the right area 811a of the polarizing filter 811 to have the same inclination of the polarization axis as the light transmitting through the left area 811b. On the other hand, the regions 802b of the micro-patterned half wave retarder 802 which have the second polarization characteristics allow the light transmitting through the left area 811b of the polarizing filter 811 to transmitted as is. Then, the lights emitted from the micro-patterned half wave retarder 802, having the same polarizations of the light transmitting through the left area 811b, are incident upon the polarizing plate 803 provided on the light source side of the liquid crystal display panel 804.

The polarizing plate 803 functions as the second polarizing plate, and has such polarization characteristics as to allow light having the same polarization as the light having transmitted through the left area 811b of the polarizing filer 811 to be transmitted. In other words, the light transmitting through the left area 811b of the polarizing filter 811 is transmitted through the second polarizing filter 803, and the polarizing axis of the light transmitting through the right area 811a of the polarizing filter 811 is rotated by 90 degrees before transmitting through the second polarizing plate 803. The polarizing plate 805 functions as the first polarizing plate, and has such polarizing characteristics as to allow light having a polarization different from the polarizing plate 803 by 90 degrees to be transmitted therethrough.

The micro-patterned half wave retarder 802, the polarizing plate 803, and the polarizing plate 805 are bonded together to the liquid crystal display panel 804, and the micro-patterned half wave retarder 802, the polarizing plate 803, the liquid crystal display panel 804, and the polarizing plate 805 are combined to constitute the image display system. At this time, in a state in which a voltage is applied to the liquid crystal, the light transmitting through the polarizing plate 803 is transmitted through the polarizing plate 805. On the other hand, in a state in which no voltage is applied to the liquid crystal, the light transmitting through the polarizing plate 803, whereof the polarization is twisted by 90 degrees, is emitted from the liquid crystal display panel 804, and hence does not transmit through the polarizing plate 805.

A diffuser 806 is mounted to the front side (viewer side) of the first polarizing plate 805, and functions as diffusing means for diffusing the light transmitting through the liquid crystal display panel in the vertical direction. More specifically, it diffuses the light transmitting through the liquid crystal display panel in the vertical direction using a lenticular lens having projections and depression of semicircular shape in cross-section provided repeatedly in the vertical direction.

Instead of the lenticular lens, the one provided with a mat diffusing surface having stronger diffusing property in the vertical direction than in lateral direction. It can improve a disadvantage that the viewing angle is narrowed by diffusion control in the vertical direction until the light is completely transmitted through the liquid crystal display panel 804.

In addition, the one or a plurality of auxiliary light sources 814 are disposed behind the light emitting device 810 as a main light source. The one or a plurality of auxiliary light sources 814 include a plurality of electric bulbs or a plurality of light emitting devices (LED or EL) or the like, which are turned on when the image is desired to be viewed by many viewers and increase the light amount transmitted through the liquid crystal display panel 804, thereby enlarging the viewing angle of a screen of the image display system 8.

Therefore, the lights from the one or a plurality of auxiliary light sources 814 are not required to pass through the polarizing filter 811, and goes through the Fresnel lens 812, the micro-patterned half wave retarder 802, the polarizing plate 803, the liquid crystal display panel 804, the polarizing plate 805, and then the diffuser 806 to reach viewers or working staff in the vicinity of the viewers.

Then, since most of the light from the one or a plurality of auxiliary light sources 814 is diffusive light which has not passed through the polarizing filter 811, the light can be irradiated entirely on the liquid crystal display panel 804 to improve the brightness of the display system 8 to widen the viewing angle of the secondary image.

FIG. 2 is a block diagram showing a drive circuit of an image display system according to an embodiment of the present invention.

A main control circuit 100 for driving the image display system 8 according to the embodiment of the present invention includes a CPU 101, a ROM 102 having a program or the like stored therein in advance, and a RAM 103 as a memory used as a work area when the CPU 101 is in operation. The CPU 101, the ROM 102, and the RAM 103 are connected by a bus 108. The bus 108 includes an address bus and a data bus which are used when the CPU 101 reads and writes data.

A communication interface 105, an input interface 106, and an output interface 107, which perform input and output with respect to the outside, are connected to the buss 108. The communication interface 105 is a data input/output section for data transmission according to a predetermined communication protocol. The input interface 106 and the output interface 107 input and output image data to be displayed on the image display system 8.

An viewer detection sensor 300 for detecting whether or not an viewer is present at a position from which the viewer can see a three-dimensional image and in a range in which the viewer can see the image display system 8 is connected to the input interface 106. The viewer detection sensor 300 includes an infrared ray sensor, a motion sensor, or a pressure sensor or the like which is provided on a seat or the like.

A graphic display processor (GDP) 156 of a display control circuit 150 is connected to the bus 108. The GDP 156 calculates image data generated by the CPU 101, writes the same to a frame buffer provided in the RAM 153, and generates signals (RGB, V BLANK, V_SYNC, H_SYNC) to be outputted to the image display system 8. The ROM 152 and the RAM 153 are connected to the GDP 156, and the RAM 153 is provided with a work area where the GDP 156 works and the frame buffer for storing the display data. The ROM 152 includes a program and data required for the operation of the GDP 156.

The GDP 156 includes an oscillator 158 for supplying a clock signal to the GDP 156 connected thereto. The clock signal for generating the oscillator 158 defines the operating frequency of the GDP 156 and generates a frequency of the synchronized signal outputted from the GDP 156 (for example, V_SYNC, V BLANK).

The RGB signal outputted from the GDP 156 is inputted to a γ corrective circuit 159. The γ corrective circuit 159 corrects a non-linear characteristic of brightness with respect to the signal voltage of the image display system 8, adjusts the illumination brightness of display of the image display system 8, and generates the RGB signal outputted to the image display system 8.

A combining and converting device 170 is provided with a frame buffer for right-eye, a frame buffer for left-eye and a frame buffer for viewing a three-dimensional image, and writes a right-eye image sent from the GDP 156 in the frame buffer for right-eye, a left-eye image to the frame buffer for left-eye. Then, the combining and converting device combines the right-eye image and the left-eye image to generate the three-dimensional image, and writes the same in the frame buffer for viewing the three-dimensional image, and outputs the image data for three-dimensional view to the image display system 8 as a RGB signal.

Generation of the three-dimensional image by combining the right-eye image and the left-eye image is done by combining the right-eye image and the left-eye image according to the regions 802a and 802b of the micro-patterned half wave retarder 802. More specifically, since the regions 802a and 802b of the micro-patterned half wave retarder 802 of the image display system 8 according to the present embodiment are disposed at intervals of the unit of display of the liquid crystal display panel 804, the image for viewing a three-dimensional image is displayed so that the right-eye images and the left-eye images are alternately displayed by each lateral line (scanning line) as the unit of display of the liquid crystal display panel 804.

The left-eye image data transmitted from the GDP 156 during output of L signal is written in the frame buffer for left-eye and the right-eye image data transmitted from the GDP 156 during output of R signal is written in the frame buffer for right-eye. Then, the left-eye image data written in the frame buffer for left-eye and the right-eye image data written in the frame buffer for right-eye are read out for each scanning line and written in the frame buffer for viewing a three-dimensional image.

The image display system 8 includes a liquid crystal driver (LCD DRV) 181, a backlight driver (BL DRV) 182, and a lamp driver 183 for driving the one or a plurality of auxiliary light sources 814. The liquid crystal driver (LCD DRV) 181 applies a voltage to the electrodes of the liquid crystal display panel in sequence based on the V BLANK signal, the V_SYNC signal, H_SYNC signal, and the RGB signal transmitted from the combining and converting device 170 to display a combined image for viewing a three-dimensional image on the liquid crystal display panel.

The backlight driver 182 changes duty ratios of voltage applied to the light emitting device (backlight) 810 as a main light source 801 and the one or a plurality of auxiliary light sources 814 respectively based on the DTY_CTR signal outputted from the GDP 156, thereby changing brightness of the liquid crystal display panel 804. The DTY_CTR signal (duty ratio) for controlling the light emitting device 810 and the duty ratio for controlling the one or a plurality of auxiliary light sources 814 are independent.

The lamp driver 183 controls turning on and off of the one or a plurality of auxiliary light sources 814 according to the control signal (LMP_CTR) from the CPU 151.

FIG. 3 is a plan view showing an optical system of the image display system 8.

Light emitted from the light emitting device 810 is passed through the polarizing filter 811 and is radially diffused. The light emitted from the light source passes through the right area 811a of the polarizing filter 811 (a dashed line indicates a center of the optical path) and reaches the Fresnel lens 812, where the direction of travel of the light is changed, then is transmitted through the micro-patterned half wave retarder 802, the polarizing plate 803, the liquid crystal display panel 804, and the polarizing plate 805 substantially orthogonally thereto (substantially from the right side to the left side), and then reaches the left eye.

On the other hand, part of the light emitted from the light emitting device 810 which is transmitted through the left area 811b of the polarizing filter 811 (a broken line indicates a center of the optical path) reaches the Fresnel lens 812, where the direction of travel is changed, is passed through the micro-patterned half wave retarder 802, the polarizing plate 803, the liquid crystal display panel 804, and the polarizing plate 805 substantially in the vertical direction (substantially from the left side to the right side), and then reaches the right eye.

In this manner, the light emitted from the light emitting device 810 and transmitted through the polarizing filter 811 is irradiated to the liquid crystal display panel 804 by the Fresnel lens 812 as the optical system substantially in the vertical direction. In other words, the light source 801 which irradiates the lights having different planes of polarization onto the liquid crystal display panel 804 substantially in the vertical direction along the different routes is configured with the light emitting device 810, the polarizing filter 811 and the Fresnel lens 812, and the light transmitted through the liquid crystal display panel 804 is emitted along the different routes and reaches the left eye or the right eye.

In FIG. 3, a position indicated by a wave line in the drawing is set as a three-dimensional image viewing zone with respect to the depth direction. The three-dimensional image viewing zone includes a reference position where only the light transmitting through the right area 811a of the polarizing filter 811 enters into the viewer's left eye, and only the light transmitting through the left area 811b of the polarizing filter 811 enters into the viewer's right eye, whereby the three-dimensional image can be recognized. Since the distance between the left eye and the right eye of the viewer is different from person to person, the three-dimensional image viewing zone is defined by the average value of the distance between the left and right eyes. Therefore, actually, as shown by a dashed line in the drawing, a predetermined range with respect to the depth direction of the image display system 8 corresponds to a three-dimensional image recognizable range. The three-dimensional image viewing zone in the horizontal direction (vertical direction in the drawing) of the image display system 8 is a correct position with respect to the center of the image display system 8 in the case of FIG. 3.

In other words, by equalizing the pitch of the scanning lines of the liquid crystal display panel 804 and the pitch of the regions having the polarization characteristics on the micro-patterned half wave retarder 802, the lights coming from the different directions are irradiated on each pitch of the scanning lines of the liquid crystal display panel 804 and hence the lights are emitted in the different directions.

On the other hand, most of the lights from the one or a plurality of auxiliary light sources 814 do not pass through the polarizing filter 811, but pass through the Fresnel lens 812, the micro-patterned half wave retarder 802, the polarizing plate 803, the liquid crystal display panel 804, the polarizing plate 805, and the diffuser 806 in a state of diffused light and reaches the viewer side. Therefore, different from the aforementioned light passed through the polarizing filter 811, the lights from the one or a plurality of auxiliary light sources 814 display the two-dimensional image without constituting the three-dimensional image. The two-dimensional image recognizable range corresponds to a range in which the viewer can see the lights passed from the one or a plurality of auxiliary light sources 814 through the liquid crystal display panel 804, the polarizing plate 805, and the diffuse 806, and is an extremely larger than the three-dimensional image recognizable range.

FIG. 4 is a flowchart of control carried out by the GDP 151, which is carried out at predetermined intervals (for example, at intervals of a cycle of vertical synchronous signals; 16.7 msec= 1/60 seconds).

In Step S1, signals from the viewer detection sensor 300 is read to detect whether or not the viewer is in the three-dimensional image recognizable range, and then determine whether or not the current detection result is changed from the previous detection result.

In Step S2, the procedure is routed according to the change of the state of the viewer. When the state of the viewer is not changed and the viewer is not in the three-dimensional image recognizable zone, the procedure goes to Step S3, and when the state of the viewer also isn't changed and the viewer is in the three-dimensional image recognizable zone, the procedure goes to Step S11. Then, regarding the case in which the state of the viewer is changed, when the state of the viewer is changed from “absent” to “present”, the procedure goes to Step S6, and when the state of the viewer is changed from “present” to “absent”, the procedure goes to Step S8.

In Step S3 in which the viewer is not in the three-dimensional image recognizable zone and the state of the viewer is not changed, the value of the timer is renewed (for example, incremented), and in Step S4, whether or not the value of the timer has become the predetermined value is determined. When the value of the timer has become the predetermined value, the procedure goes to Step S5, where the light source control process as described later is performed, and when the value of the timer has not become the predetermined value, the procedure is ended as is.

In Step S11 in which the viewer is in the three-dimensional image recognizable range, and the state of the viewer is not changed, turning-on control of the light emitting device 810 as a main light source is performed at a predetermined duty ratio.

On the other hand, in Step S6 where the state of the viewer is changed from “absent” to “present”, the one or a plurality of auxiliary light sources 814 are turned off and only the main light source 810 is turned on, and then the procedure goes to Step S7, where the image to be displayed on the image display system 8 is switched from an two-dimensional image having no parallax (two-dimensional image) to the three-dimensional image having parallax (image for displaying a three-dimensional image).

In Step S8 where the state of the viewer is changed from “present” to “absent”, the image to be displayed on the image display system 8 is switched from the three-dimensional image having parallax (image for displaying a three-dimensional image) to the two-dimensional image (two-dimensional image) having no parallax, and in Step S9, the one or a plurality of auxiliary light sources 814 are turned on to increase the light amount which is transmitted through the liquid crystal panel display 804.

Then, in Step S10, the timer is initialized (for example, zero-reset) to end the procedure.

In the light source control process performed in the above-described Step S5, when the value of the timer exceeds a predetermined value, the one or a plurality of auxiliary light sources 814 are turned off to control heat generation and power consumption of the light sources.

Alternatively, when the value of the timer exceeds a predetermined value, the one or a plurality of auxiliary light sources 814 are made to blink, whereby the heat generation and the power consumption of the light sources can be controlled while displaying the two-dimensional image continuously. In the one or a plurality of auxiliary light sources 814 which include a plurality of the light emitting members, light emitting members may be divided into groups and light emission control may be applied to those groups to make them blink alternately.

With the above-described control, when the state is changed from a state in which the viewer is “absent” to “present” in the three-dimensional image recognizable zone of the image display system 8, the one or a plurality of auxiliary light sources 814 are turned off and then the two-dimensional image is switched to the image, so that only the light emitting device 810 as a main light source is turned on to provide the three-dimensional image to the viewer who is present at a predetermined position.

At this time, since switching to the three-dimensional image is done after the one or a plurality of auxiliary light sources 814 are turned off, both of the left-eye image and the right-eye image reach the both eyes by illumination of the one or a plurality of auxiliary light sources 814. Therefore, by switching to the three-dimensional image after turning off the one or a plurality of auxiliary light sources 814 to cause the light from the light emitting device 810 as a main light source to reach the viewer's both eyes, generation of cross-talk of the left-eye image and the right-eye image can reliably be prevented, and hence switching from the two-dimensional image to the three-dimensional can be performed smoothly without giving a feeling of discomfort to the viewer.

On the other hand, when the state is changed from the state in which the viewer is “present” to “absent” in the three-dimensional image recognizable zone of the image display system 8, the image to be displayed is switched from the three-dimensional image to the two-dimensional image, and then the one or a plurality of auxiliary light sources 814 are turned on.

When the one or a plurality of auxiliary light sources 814 are turned on, the brightness of the image display system 8 (the light amount of the liquid crystal display panel) increases and the viewing angle of the image display system 8 increases by the diffusing light from the one or a plurality of auxiliary light sources 814 which is not passed through the polarizing filter 811, and hence the two-dimensional image can be provided to the viewer who is out of the three-dimensional image recognizable range. Therefore, for example, demonstration images which are intended to be viewed by unspecified viewers can be displayed effectively.

Since it is adapted to turn on the one or a plurality of auxiliary light sources 814 after having switched the three-dimensional image to the two-dimensional image, the left-eye image and the right-eye image are prevented from reaching to the both eyes due to the one or a plurality of auxiliary light sources 814 which provide diffusing light, and hence generation of cross-talk in the three-dimensional image is prevented, whereby switching from the three-dimensional image to the two-dimensional image can be carried out without giving feeling of discomfort to the viewer.

Then, when the state of “absent” is continued for a period exceeding the predetermined value, the one or a plurality of auxiliary light sources 814 can be turned off or made to blink by controlling the light source, and hence heat generation and power consumption of the light source can be controlled.

In this manner, since it is adapted to switch between the three-dimensional image and the two-dimensional image depending on the presence or absence of the viewer and to turn on the one or a plurality of auxiliary light sources 814 depending on the type of the image, the characteristics of the light emitting device 810 as a main light source for irradiating the light for the left eye and the light for the right eye independently and the one or a plurality of auxiliary light sources 814 for irradiating diffusing light and providing the wide viewing angle are selectively used as needed, so that an optimal image (a three-dimensional image or a two-dimensional image) can be displayed according to the position of the viewer.

Also, since the one or a plurality of auxiliary light sources 814 are arranged behind the light emitting device 810 as a main light source, in other words, since the light emitting device 810 as a main light source is disposed between the one or a plurality of auxiliary light sources 814 and the Fresnel lens 812, the light of the light emitting device 810 as a main light source can be irradiated to the Fresnel lens 812 and the liquid crystal display panel 804 as is without being intercepted by the one or a plurality of auxiliary light sources 814 when displaying the three-dimensional image, so that the light from the light emitting device 810 can be transmitted to the viewer efficiently and hence the clear three-dimensional image can be provided.

In this manner, since the present embodiment is adapted to turn on the one or a plurality of auxiliary light sources 814 and the main light source 810 simultaneously when displaying the two-dimensional image, the light amount transmitted through the liquid crystal display panel 804 increases and hence the viewing angle can be widened, whereby the range in which the two-dimensional image is recognizable can be widened.

It is also possible to turn off or dim the light emitting device 810 as a main light source when turning on the one or a plurality of auxiliary light sources 814. In this case, by using only the one or a plurality of auxiliary light sources 814 for displaying the two-dimensional image, heat generation and power consumption of the light emitting device 810 as a main light source can be controlled to improve durability of the system and promotion of energy saving.

In the above-described embodiment, it is preferable to set the brightness of the one or a plurality of auxiliary light sources 814 higher than the brightness of the light emitting device 810 as a main light source, and type of the light emitting devices used for the respective light sources, the number of the light emitting devices, the current or voltage to be supplied to the light emitting devices, the blinking duty ratio of the light emitting devices and so on, must be selected as needed.

In the case in which the one or a plurality of auxiliary light sources 814 and the light emitting device 810 as a main light source are turned on simultaneously when displaying the two-dimensional image, the light amount transmitted through the liquid crystal display panel 804 increases, and hence the viewing angle can be widened, and hence the range in which the two-dimensional image is recognizable can be widened.

Although drive of the light emitting device 810 as a main light source is set to a predetermined duty ratio in the above-described embodiment, in the case in which the viewer is “present” in the three-dimensional image recognizable zone, the light emitting device 810 may be driven at the maximum brightness.

Alternatively, as shown in FIG. 5, the one or a plurality of auxiliary light sources 814 may be a surface light source 814A, and in this case, the viewing angle can be widened by increasing the brightness when displaying the two-dimensional image.

It must be understood that the embodiment disclosed in this specification is not intended to limit the invention, and is disclosed simply as an example at all events. The scope of the present invention is not defined by the description described above, but defined by claims, and all the modifications covered within the claims and equivalent thereto are included in the invention.

1. An image display system comprising a liquid crystal display panel being irradiated by a backlight and having a left eye image area and a right eye image area on a display area respectively, optical means for allowing light from the backlight to be transmitted to the left eye image area and the right eye image area and causing the transmitted lights from the respective image areas to enter into a left eye and a right eye of an viewer independently, and image parallax switching means for selectively displaying a three-dimensional image which causes parallax between the both eyes of the viewer when showing a three-dimensional image to the viewer or a two-dimensional image which does not cause parallax between the both eyes when showing a two-dimensional image to the viewer on the display area, characterized in that an one or a plurality of auxiliary light sources for irradiating the liquid crystal display panel and causing the irradiated light to be transmit through the left eye image area or the right eye image area and enter into the both eyes of the viewer and light source control means which turns on the backlight when showing the three-dimensional image to the viewer, and turns on the one or a plurality of auxiliary light sources when showing the two-dimensional image to the viewer are provided.

2. The image display system according to claim 1, characterized in that when the image parallax switching means switches the image to be shown to the viewer from the three-dimensional image to the two-dimensional image, the one or a plurality of auxiliary light sources are turned on by the light source control means after switching to display from the three-dimensional image to the two-dimensional image by the image parallax switching means.

3. The image display system according to claim 1 or 2, characterized in that when the image parallax switching means switches the image to be shown to the viewer from the two-dimensional image to the three-dimensional image, the display is switched from the two-dimensional image to the three-dimensional image by the image parallax switching means after turning off the one or a plurality of auxiliary light sources by the light source control means.

4. The image display system according to any one of claim 1 to claim 3, characterized in that the light source control means turns off or dims the backlight when the one or a plurality of auxiliary light sources are turned on.

5. The image display system according to any one of claim 1 to claim 3, characterized in that the light source control means also turns on the backlight when turning on the one or a plurality of auxiliary light sources.

6. The image display system according to any one of claim 1 to claim 5, characterized in that the one or a plurality of auxiliary light sources are higher in brightness than the backlight.

7. The image display system according to any one of claim 1 to claim 6, characterized in that the backlight is disposed between the liquid crystal display panel and the one or a plurality of auxiliary light sources.

8. The image display system according to any one of claim 1 to claim 7, characterized in that the one or a plurality of auxiliary light sources are composed of one or a plurality of surface light source.

9. The image display system according to any one of claim 1 to claim 8, characterized in that viewer detection means for detecting existence of the viewer is provided, and the light source control means turns on the one or a plurality of auxiliary light sources when the existence of the viewer is not detected by the viewer detection means.
